(19) United States
(12) Patent Application Publication
(10) Pub. No.: US 2004/0128233 A1
(43) Pub. Date: Jul. 1, 2004

(54) Loan financing and investment method

(76) Inventor: Henry J. Jarzmik, Mississauga (CA)

Correspondence Address: DENNISON ASSOCIATES, 133 RICHMOND STREET WEST, SUITE 301, TORONTO, ON, M5H 2L7, CA

(21) Appl. No.: 10/684,387

(22) Filed: Oct. 15, 2003

Related U.S. Application Data
(63) Continuation-in-part of application No. 09/573,386, filed on May 18, 2000, now abandoned.

(51) Int. Cl. G06F 17/60

(52) U.S. Cl. 705/38; 705/36; 705/4

(57) ABSTRACT

A method for financing a loan of an amount loaned to a borrower comprising the steps of selecting a reference loan having an amount equal to the loan amount; selecting the terms of the reference loan; calculating a periodic payment paid under the reference loan; loaning the borrower a loan amount; selecting an investment instrument into which the borrower will invest preselected investment amounts; and receiving the value of the investment instrument at a preselected time in satisfaction of the loan. The method of financing is designed to reduce the length of time required to repay the loan and to provide greater security to a lender through the ability to seize the investment instrument in addition to the collateral on the loan.

This is a Continuation-In-Part Application of U.S. patent application Ser. No. 09/573,386 filed May 18, 2000 entitled LOAN FINANCING AND INVESTMENT METHOD.

### FIELD OF THE INVENTION

This invention relates to a method for loan financing, and more particularly to a method for reducing the length of a loan.

### BACKGROUND OF THE INVENTION

In North America, business and personal loans made by lending institutions are typically repaid by the borrower through the use of monthly payments which cover both the interest charged on the loan and a portion of the principal of the loan. The interest rates may be fixed or variable and the length of the loan can vary.

A typical house purchase is financed by means of a loan from a bank or other lending institution. The house buyer provides a down payment of 10 to 25 percent of the purchase price of the house and the bank provides the remainder of the purchase price. The house buyer enters into a mortgage agreement with the bank, where the bank obtains a security interest in the house as collateral. The house owner then makes regular equal monthly payments typically based on a 25 to 30 year amortization period. The house owner will typically enter into a 3 to 5 year agreement with the bank where the monthly payments are fixed. This agreement is renewed until the loan is repaid. Initially, the bulk of the monthly payment will be devoted to the payment of interest on the outstanding loan amount. Some of the payment, however, will be used to repay the principal of the loan. As the principal is slowly repaid, the interest component is reduced. A reduction of the interest payment leads in turn to a faster repayment of the principal. If the monthly payments remain at a constant level, and the mortgage is renewed every 3 to 5 year period, the mortgage will be repaid in 25 to 30 years. Should the homebuyer default on a loan, the bank may seize the home and sell it to recover the principal of the loan. If the house price falls below the amount of the principal, the bank will lose money and must try to recover the outstanding loan amount from a borrower who may not have the means to repay the outstanding loan amount.

Another common feature of financing loans for house purchases is the use of life insurance to guarantee the payment of the loan in the event of the death of the mortgagee. Under this method of financing, the homeowner pays an interest rate premium to finance the purchase of life insurance on their own life payable to the bank or credit union. Thus, their families are not burdened with the loan payments in the event of their death.

In recent years, after the sharp rise in home prices in the 1980's, new methods of financing house purchases have been sought. U.S. Pat. No. 4,876,648 to Lloyd discloses a method for repaying a mortgage loan where the borrower only makes interest payments on the principal and the lender invests in a life insurance policy on the life of the borrower in order to repay the principal after a 30 year mortgage length. In this method the lender's cost in insuring the life of the borrower is offset by increased interest payments from a higher interest rate. The borrower benefits over the 30 year term as well by taking advantage of the market returns on the life insurance policy to repay the principal and the increased tax savings resulting from the tax deductibility of mortgage interest payments. A disadvantage of the system, however, is that the amount of money invested that is receiving market rates of return is limited to the insurance premiums paid by the bank. As well, there is no reduction in the term of the mortgage.

U.S. Pat. No. 5,907,828 to Meyer et al. describes a method of providing bank-owned life insurance on the life of the borrower without fees and extra interest charges. Under this method, the bank purchases a mortgage life insurance policy from an insurance company and borrows the maximum amount from that policy and invests the money to earn a greater rate of return. After a certain amount of the cash value of the insurance policy has been loaned to the bank, the bank may make cash withdrawals on the policy in order to support its cash flow requirements. Under this method the bank reduces its risk and increases its return by having mortgage life insurance on all of its borrowers and not merely those who opt to obtain mortgage life insurance. The borrower saves money by not having to pay an interest premium for mortgage insurance. A disadvantage of this system is that the borrower does not benefit from the increased market returns.

U.S. Pat. No. 5,673,402 to Ryan et al. describes another method of financing a house purchase. The usual down payment is replaced with an insurance purchase. The insurance purchase is used to purchase a life insurance policy on the life of the borrower payable to the lender to cover the mortgage principal. The borrower than makes regular interest payments on the principal until the cash value of the life insurance policy is sufficient to completely repay the principal of the loan. Under this method, the cash needed by the borrower up front is greatly reduced (from 20 percent to 12 percent of the home purchase price in the example shown in the patent) and the bank has additional security in both the collateral of the home and the life insurance policy. A disadvantage of this system is that, as in the Lloyd method, most of the payments made over the life of the mortgage are interest payments and are not subject to market rates of return in order to reduce the length of the mortgage.

Accordingly, there is a need for a method of financing a loan where the borrower can reduce both the term of the loan and the total payments made under the loan as compared to a conventional loan arrangement. As well, there is a need for providing the lender of this method with additional collateral in the event of a default by the borrower.

### SUMMARY OF THE INVENTION

The present invention is directed to a method for financing a loan of a loan amount to a borrower beginning with the selection of a reference loan having an amount equal to the loan amount and a preselected amortization period, interest rate and period of payment. A periodic payment amount is then calculated, the periodic payment amount including interest and principal components such that at the end of the reference loan length, the loan would be repaid in full. An investment instrument, such as a life insurance policy, is then selected, having a preselected estimated rate of return. The lender then arranges to have the borrower periodically invest preselected investment amounts in the investment instrument wherein the preselected investment amount is correlated to the periodic payment of the reference loan. At a preselected time, the value of the investment instrument is received in satisfaction of the loan. The preselected time is based on the estimated rate of return.

Another aspect of this invention is a method for financing a loan of a loan amount to a borrower by a lender. The loan is secured by a mortgage security on a property, and the borrower comprises at least one individual. It is arranged for the borrower to periodically make a premium payment on a life insurance policy on the life of the borrower. The lender is named as beneficiary of the policy and the policy is cashable for a cash surrender value. At least a portion of the premium payment is invested in at least one investment vehicle, wherein the investment vehicle has a preselected estimated rate of return. A cash surrender value of the life insurance policy is calculated based on the portion of the premium payment to be invested in the investment vehicle and the preselected estimated rate of return. The proceeds of the investment vehicle are periodically applied to increase the cash surrender value of the policy. Finally, the cash surrender value is received at a preselected time in full satisfaction of the loan, wherein the preselected time is based upon the estimated cash surrender value.

### BRIEF DESCRIPTION OF THE DRAWINGS

Preferred embodiments of the invention are shown in the drawings, wherein:

The invention will now be described, by way of example only, with reference to the following drawings, in which:

FIG. 1 is a block diagram of a preferred embodiment of the present invention;

FIG. 2 is a flow chart illustrating the method of the present invention;

FIG. 3 is a flow chart of a reference mortgage known in the prior art; and

FIG. 4 shows a computer system used to generate a contractual agreement and to track the investment terms of the agreement.

### DETAILED DESCRIPTION OF THE PREFERRED EMBODIMENTS

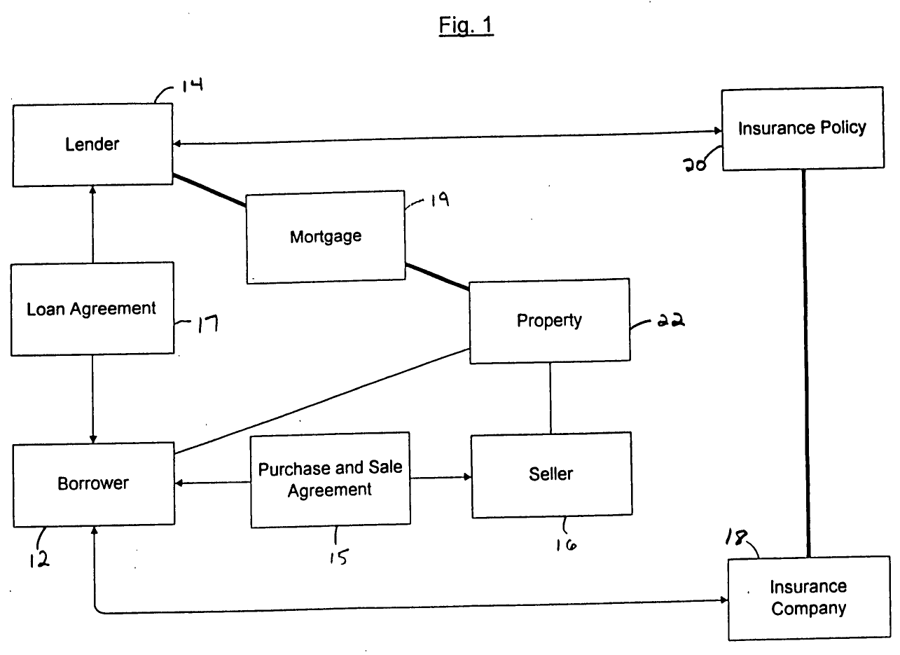

Referring to FIG. 1, in a typical series of transactions made in accordance with a preferred embodiment of the present invention, borrower 12 enters into purchase and sale agreement 15 with seller 16 to purchase property 22, which is typically a house located on a piece of real property, but may be any piece of real, personal or intangible property. Borrower 12 may comprise one or more individuals. Assuming that borrower 12 does not wish to, or is not able to, pay the entire purchase price to seller 16 at the time of purchase, borrower 12 enters into a loan agreement 17 with lender 14 to borrow the required funds. In the case of a purchase of real property, lender 14 will typically take a security interest in property 22. In the case of a house purchase, this security interest will be in a form of a mortgage 19.

Instead of taking payments for the loan from borrower 12 directly, lender 14 will arrange with insurance company 18 for a universal life insurance policy 20 on the life of borrower 12. This life insurance policy will be owned by lender 14. In addition, lender 14 will be the beneficiary of the policy to the extent any monies remain owing. Borrower 12 will make premium payments on this insurance policy according to the terms of loan agreement 17 between borrower 12 and lender 14. At the end of the loan, the insurance policy is cashed and the proceeds are given to lender 14 in satisfaction of the loan. It will be appreciated that lender 14 and insurance company 18 may be the same entity.

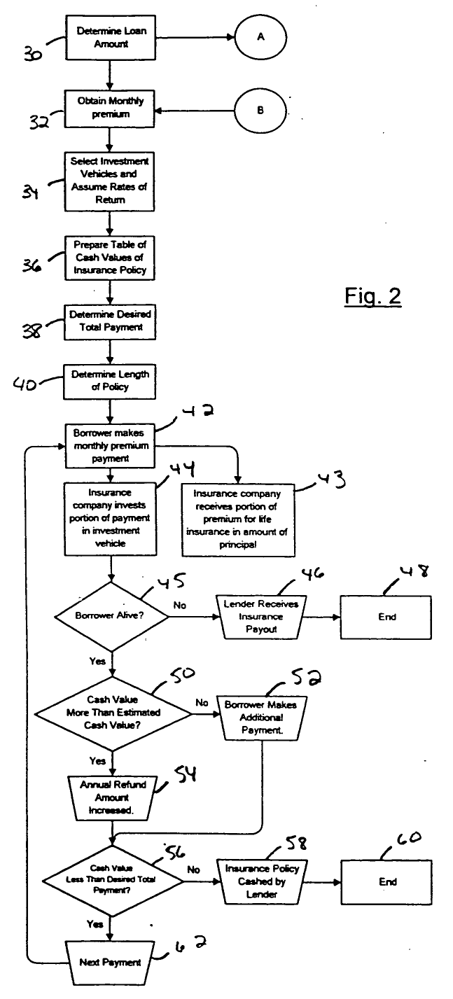

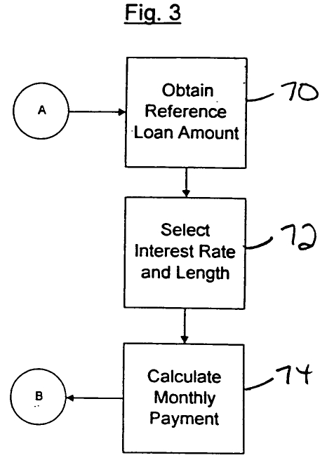

FIGS. 2 and 3 illustrate the method in greater detail and are typically initially established and tracked over time using a computer. After borrower 12 approaches lender 14 to arrange for a loan to purchase house 22, the loan amount is determined at step 30. The loan amount is usually equal to the purchase cost of the house, including any taxes, legal fees, or other purchase costs, less the down payment paid by the borrower. The down payment is typically in the range of 10 to 25 percent of the total purchase price. This loan amount is output to FIG. 3 through marker A. FIG. 3 shows the process for determining the monthly premiums and the total desired cash value of the insurance policy. The first step in making these determinations is to calculate and determine a reference loan amount 70, wherein the reference loan is a hypothetical loan based on current loan terms offered by lender 14. The amortization period of the loan and interest rate are selected at step 72. The amortization period of the loan is typically 25 to 30 years. This is the time over which a typical homeowner can expect to pay off such a loan. The interest rate is generally fixed at the current interest rate that lender 14 would charge borrower 12 over a five-year term, although other interest rates can be used. At step 74, the monthly payment of the reference loan can be calculated by lender 14 according to known methods based on the loan amount, length and interest rate of the reference loan. The monthly payment is designed such that the reference loan would be completely paid over the length of the loan through the use of blended interest and principal payments. This monthly payment is output through marker B to FIG. 2. It will be appreciated that the payment need not be calculated on a monthly basis but that any regular period of payment may be used such as 1 week, 2 weeks, 2 months, etc. Preferably, the period of payment will be the typical period of payment for a loan that lender 14 would give borrower 12 in a typical mortgage loan financing.

Returning to FIG. 2, the monthly payment is input from marker B to step 32 to determine a monthly premium. The monthly premium is set equal to the monthly payment calculated under the reference loan. The monthly premium will be paid into a universal life insurance policy 20 on the life of borrower 12, as set out hereinafter. It will be appreciated that other amounts may be selected for the premium and that other periods of payment may be used. Preferably, the amounts are similar to the monthly payments so as to attract potential borrowers.

A rate of return is selected at step 34 of the process. This rate of return is generally based on historical stock market or mutual fund performance. The monthly premiums will be invested by insurance company 18 in one or more of a variety of market investment products and the selected rate of return should reflect the planned investment methods. At step 36, a table of cash values of the universal life insurance policy is prepared. This table shows the cash value of a policy on a monthly basis, given the monthly premium from step 32 and the rate of return selected in step 34. This table of cash values is prepared over a period of time similar to that of the length of the reference loan.

At step 38, the desired cash value of the insurance policy is selected by the lender. This value is compared to the cash values of the policy in the table prepared at step 36, in order to determine the length of the policy at step 40. For example, if the desired total payment is $300,000 after 25 years and the cash value of the insurance policy after 15 years of monthly premium payments is also $300,000, the length of the policy is 15 years.

After the policy length is determined and the terms of the loan are agreed to, borrower 12 begins making monthly premium payments at step 42. The premium payments are paid to insurance company 20. At step 43 a portion of the premiums will be put towards a life insurance policy in the amount of the principal of the loan while at step 44 the remainder will be invested in a variety of investment products including stocks, bonds, mutual funds, treasury bills etc. The investment products may be chosen by insurance company 18 or may fall within a set of vehicles chosen by borrower 12. For example, borrower 12 may have an aversion to risk and may specify that the premiums may only be invested in stock market index products or blue chip stocks. It will be appreciated that lower risk investments will likely receive lower rates of return. To compensate, borrower 12 may be required to pay premiums over a longer term, or borrower 12 be required to pay larger monthly premiums at step 32 than they would under a conventional mortgage.

It is also possible for the insurance company to mirror the named investments rather than make the actual investment. From the customer standpoint, there is no difference as the calculated ratio of return will be identical to the return of the named investments. The main difference is with respect to the insurance company where-alternate investments at their own risk can be made.

At step 45, lender 14 checks to ensure that borrower 12 is still alive. By default, lender 14 may assume that borrower 12 is alive unless informed to the contrary. If borrower 12 is not alive, the process flows to step 46 where lender 14 is the beneficiary of life insurance policy 20. Lender 12 receives the full death benefit and the cash value of the policy in satisfaction of the loan. Flow moves to step 48 and the method comes to an end as the lender 14 has received full payment for their outstanding loan, and the estate of the borrower receives house 22 without encumbrance by lender 14.

If borrower 12 is still alive at step 44, the flow moves to step 50. At this point the cash value of the policy is compared to the estimated cash value from the table prepared at step 36 for the same time period. Because the rate of return selected for the table prepared at step 36 is an estimated rate of return, and the rates of return on the investment will vary over time, the lender must ensure that policy 20 is on track to provide a full cash payout at the end of the length of policy 20. If the investments made within life insurance policy 20 have been performing worse than expected, and the cash value of policy 20 is less than the estimated cash value as determined in step 36, borrower 12 will be required to make additional premium payments into the policy, to ensure that the cash value of the policy is at least equal to the estimated cash value. This tracking is carried out by a computer based on the selected investment instruments. A notice to the borrower requiring additional funds and indicating any surplus can be automatically produced on a monthly or other periodic basis.

Step 50 may be performed on a less frequent basis, for example on a bi-monthly, semi-annual, or annual basis. Preferably, step 50 is performed monthly because in the event the investments are under-performing, it is less likely that borrower 12 will be faced with an additional large premium payment that borrower 12 will be unable to pay in a timely manner. If step 50 is performed less frequently, borrower 12 faces a greater risk that they will be required to make an additional large premium payment within a short length of time. It is also possible to agree, as part of the loan agreement, that any surplus up to a certain amount is held to effect any deficiencies that may occur in the future.

As an optional step to this process (not shown), borrower 12 may voluntarily chose to make additional premium payments at any time during the policy. This could reduce the amount of time required to repay the loan by reducing the time required for the policy to reach the desired cash value. Additional premiums could be applied against the loan principle or made as an investment in the investment instrument.

In the event that the cash value is greater than the estimated cash value as determined by the table prepared in step 36, insurance company 18 may pay the surplus to borrower 12. In the preferred embodiment, insurance company 18 may set up a refund account where the surplus is deposited. The refund account is transferred to the borrower 12 from time to time. However, borrower 12 may choose to leave the refund account on deposit with insurance company 18 to either cover any potential shortfalls or to be applied to the policy including reinvestment in the investment instrument.

The method then flows to step 56 where the cash value of policy 20 is compared to the desired total payment from step 38. If the cash value of the policy is equal to or greater than the desired total payment, insurance policy 20 is cashed and the funds are transferred to lender 14 in complete satisfaction of the loan. This will end the loan between borrower 12 and lender 14 at step 60. Otherwise, the process returns to step 42 and borrower 12 makes his next monthly premium payment.

Step 52 is optional to the process and may be subject to limits. For example the lender may require additional payments at step 52 only if the current cash value of the policy is less than the estimated cash value of the policy by a certain amount such as 10 percent of the estimated cash value.

As well, lender 14 may choose to set upper and lower limits on the rate of return where no additional payment or refund of surplus is required. For example, if the rate of return assumed at step 34 is 8%, lender 14 may stipulate that borrower 12 will not be required to make additional payments as long as the actual rate of return of the investment is greater than 7%. Borrower 12 will only be required to make additional payments at step 52 if the investment falls below 7% and then only so much as is required to bring the cash value of the policy to where it would have been if the policy had a 7% rate of return. As well, lender 14 may stipulate that no surplus will be paid at step 54, unless the actual rate of return of the investment over the period at which step 50 is performed exceeded 9%. Should the investment exceed a 9% rate of return, then any surplus over and above the 9% rate of return is placed in the refund account at step 54. As well, the use of such limits affects the calculation at step 56. If the rate of return of the investments made by the insurance company is lower than anticipated, then after the length of the policy determined at step 40, the cash value of the policy will be lower than the desired total payment. However, the lender takes the risk that the policy will underperform expectations and will still cash the policy at step 58 at the end of the length of the policy. Likewise, if the investments made outperform the rate of return assumed at step 34, the cash value of the policy will be greater than the desired total payment before the end of the length of the policy determined at step 40. Borrower 12, however, will still be required to make the monthly premium payments until the end of the length of the policy. Essentially, the lender assumes a certain level of risk and may also obtain greater payments.

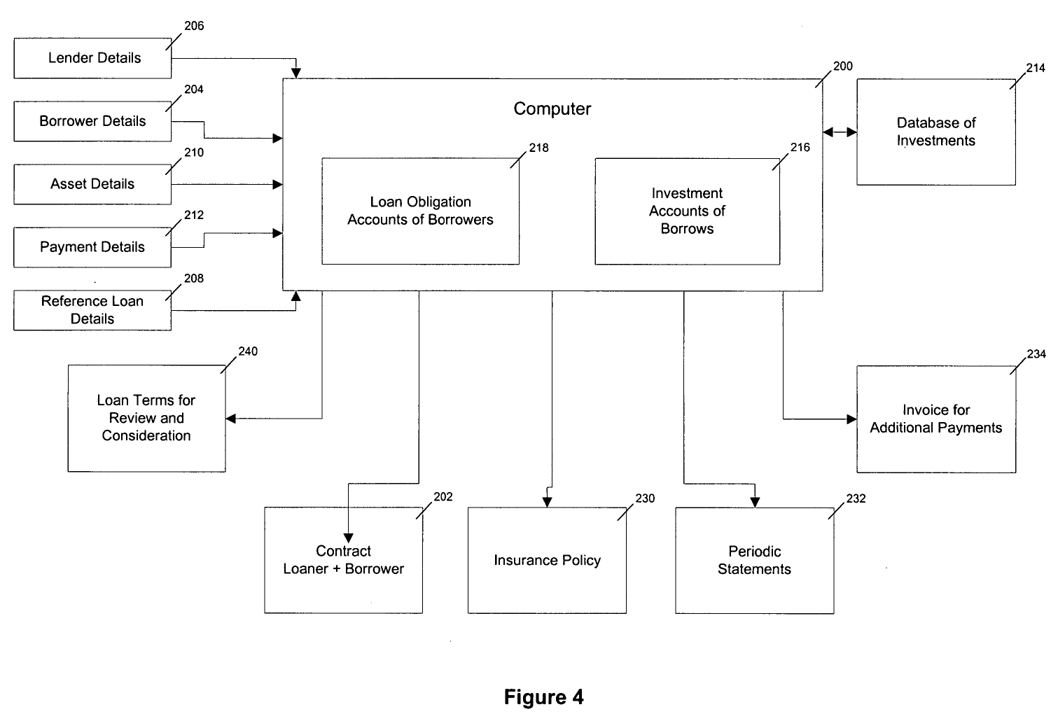

In FIG. 4, an overview of the operations of the computer 200 are shown. The computer system 200 requires certain details in order to allow output of the contract 202 between the borrower and the lender. In particular, the computer is provided with the borrower details 204, the lender details 206, the reference loan details 208, and in the case of a loan to purchase an asset, the asset details 210. The payment details generally shown at 212 are varied to accommodate the financial situation of the borrower. This is based on the particular investment vehicle and insurance, and/or other guaranteed portions of the loan.

The computer 200 also has available to it, directly or indirectly, a database of investments 214. This database provides historical or anticipated rates of returns of the various investments which are used by the computer 200 to determine how the eventual investment account of the borrower shown as 216 effectively offsets his loan obligation account 218. Preferably, for each borrower, there would be an investment account, as well as a loan obligation account. The loan obligation account 218 increases over time based on the reference loan rates which typically are the normal market rates for the particular type of loan being advanced. In contrast, the investment account is based on the monthly payment, the costs of any insurance and the investment or the capital that is invested in the borrower's name for accumulation within that account. In the preferred embodiment, this is a universal life insurance policy where the account grows in a tax exempt manner.

The computer 200 also produces for review by the lender and borrower the loan terms for review and consideration as indicated at 240. Various options can be considered to assist in evaluating the merits of this financial arrangement. Preferably the computer 200 includes one or more terminals to assist a borrower in understanding how the arrangement functions and changes with different terms and investment options. When the parties have agreed the contract and insurance policy can be completed. These are preferably separate agreements but could be combined.

Once the borrower and the lender have agreed on the various monthly payment and the type of investment to be pursued on the borrower's behalf, the computer will produce a contract identifying the various terms of the agreement and providing the necessary security interests in the asset and providing at least details of an insurance policy indicated as 230. As can be appreciated from the prior description, the lender is a named beneficiary of the insurance policy to the extent that the loan obligation remains outstanding if certain events occur.

The computer 200 will also produce periodic statements for the benefit of the borrower indicating the performance of the investment portfolio. Basically, the computer will monitor the investment portfolio of the borrower which was the basis of the agreement to offset the loan obligation and this is easily accomplished due to the database of investments. This database is maintained on a current basis and therefore the actual rate of return can be compared to the rate of return of the loan obligation. More importantly, the computer 200 can track the value of the borrower's investment account versus his loan obligation account. As long as the investment account is higher than the loan obligation account, the arrangement is working satisfactorily. If the investment account is substantially lower than the loan obligation account, a problem exists which requires certain changes in the contract which can be indicated in the periodic statement 232 automatically generated by the computer 200. In addition, this situation can be corrected by producing the invoice indicated as 234 requiring the borrower to make an additional payment. Depending upon the extent of the shortfall, the computer 200 can automatically extend in the event of a shortfall, the duration of the contract to make up for any shortfall. Another approach would be to increase the monthly payments to make up for any shortfall and to balance the investment return versus the loan obligation requirements. For example, a new anticipated rate of return can be used and the payments adjusted. This is needed when the initial anticipated returns are no longer appropriate based on experience.

The present system provides a simplified automated system for entering into an agreement between a borrower and a lender where a reference loan is tied to an investment account and preferably where the investment account includes a life insurance product such as a universal life insurance product. This type of product is beneficial in that any gains in the value of the account are accumulated on a tax exempt or tax free basis. Other investment products may become available which also have this tax free status. This is highly beneficial to the plan in that the annuity payments are essentially invested and the compounding effect is accelerated due to the tax free status. Any such tax free vehicle will provide similar benefits. The value of the investment account after tax would offset the loan obligation account.

The computer 200 also tracks the payments required of the borrower and produces appropriate notices for the borrower to correct the breach of the contractual terms. Also, the computer will alert the lender of any contract breach condition.

The automated method has described various options that are available for addressing actual ratio of return that are higher or lower than the anticipated rate of return for the agreed investment strategy. In particular, payout of any excess funds or additional make-up payments have been described. It is also possible to partially or fully address these differences by adjusting the amortization period. In the case of a higher rate of return, the amortization period can be reduced and in the case of any shortfall, this period can be increased. It is also possible to use a combination of these approaches for addressing variations in the actual rate of return.

The method described herein assumes a level cost of insurance i.e. constant monthly payment level. It will be appreciated that the monthly payment can be set to increase over time to correspond to the greater risk of death of borrower 12. As well, a mixed variable and level cost policy may be used where during the first portion of the policy, the payments are variable and during the remainder of the policy, the payments are fixed.

Borrower 12 may select the option to have disability insurance payable on their disability in addition to the life insurance. Should borrower 12 become disabled, and not be able to work, the insurance company will waive the payments during the period of disability. In the case of a total disability, lender 14 receives the cash value of the policy and the disability benefit. Borrower 12 will own the house without encumbrance by lender 14.

Borrower 12 may optionally comprise more than one person. For example, a husband and wife may jointly apply for the loan and the insurance policy. The method would operate in the same way except that should one of the couple die prior to the completion of the policy, lender 14 would only cash one-half or more of the policy and receive one-half or more of the death benefits. It is also possible for more than one person to apply on a multilife basis.

There are a number of advantages to this method for both borrower 12 and lender 14. Borrower 12 will find that, in most situations, the length of policy 20 will be significantly less than the length of a standard loan, while his monthly payments remain approximately the same. This results in great cost savings for borrower 12. Borrower 12 also receives life insurance protection at no additional charge. Finally, borrower 12 may elect to continue insurance coverage making payments into insurance policy 20 which may be lower than the payment borrower 12 would have to make if he started a new policy. This is due to the fact that borrower 12 is many years older at the end of the loan than at the beginning, and the premium payments under a new policy would be as a result.

Lender 14 also benefits from this method by obtaining greater protection in the event of default by borrower 12. If the market value of house 22 is less than the amount of the loan outstanding at default, a lender under a conventional mortgage loan will likely lose money as their only remedy is to seize the home, sell it and sue the borrowers for the remainder. It is generally difficult to successfully gain judgments for the remainder against borrowers who have defaulted on their loan payments as such defaulting borrowers are often in financial difficulties. Under a preferred embodiment of this method, lender 14 can also cash insurance policy 20 as well, thus providing extra security.

It should be appreciated that the method of the present invention is not restricted to the use of life insurance policies. Borrower 12, who may comprise any legal entity, may be required to invest in one or more of a wide variety of investment instruments such as bonds, guaranteed investment certificates, mutual funds, annuities etc. Preferably the payments and/or returns of these other investment instruments are not taxable. These investment instruments may be managed by the borrower, the lender or a third party. In a manner similar to the preferred embodiment, the value of the investment instruments will pass to the lender at the end of the loan period defined by the loan agreement in satisfaction of the loan. Universal life insurance policies offer a number of advantages over other known investment instruments however. First, the return on the investment inside the policy is not taxed, allowing for greater rates of return. Second, should borrower 12 die before the policy is cashed, lender 14 will receive the full death benefit and the cash value of the policy free of tax. However, borrower 12 will need to comprise one or more individuals and cannot be a corporation or other such legal entity as life insurance cannot be obtained on such entities.

### EXAMPLE

The following is an example showing the operation of a preferred embodiment of the method. A 30 year old borrower decides to buy a house for $230,000 for which he makes a $30,000 down payment. The borrower approaches a lender for the remainder of the purchase price of the house. The lender loans the borrower $200,000 which is paid to the seller of the house.

The lender calculates the monthly payment of a reference loan based on an interest rate of 8%, a period of payment of one month and a loan length of 30 years. Using standard amortization calculations, the lender determines that a monthly payment under the reference loan would be $1,449,42. The lender and borrower agree on an investment strategy with a moderate level of risk and an estimated rate of return of 8%. The lender then prepares a table of values of the universal life insurance policy on a yearly basis showing the cash surrender value of the policy after each year of the policy given a monthly premium of $1,449.42. In preparing this table, the lender takes into account the cost of a life insurance policy on the life of the borrower for the amount of the principal (i.e. $200,000). As the investment in the life insurance policy is allowed to grow on a tax-free basis, after 15 years, the cash surrender value of the policy is $387,891. The lender selects this value as a desired total payment and sets the terms of the loan. The borrower, under the terms of the loan, is not required to make additional payments unless the rate of return of the falls below 7% and is not entitled to receive surplus amounts unless the rate of return exceeds 9% in any given year.

The borrower then makes the monthly premium payments into a universal life insurance policy owned by the lender over 15 years. The insurance company operating the policy takes a portion of the premium payments as payment for a standard life insurance policy on the life of the lender. The remainder is invested according to the instructions of the lender. At the end of each year, the lender assesses the rate of return on the money invested by the insurance company. If the rate of return falls between 7% and 9% each year, the borrower does not make additional payments and the borrower does not die during the term of the loan, at the end of 15 years, the lender will cash the life insurance policy and the loan will be repaid. If the rate of return for a given year is greater than 9%, the lender will be required to refund any amount earned in excess; if the rate of return is less than 7%, the borrower will have to make additional payments to ensure that the cash value of the policy is at the level it would have been had the rate of return been 7%.

With this method, the investment portfolio instrument is within an insurance product such as a universal life policy and is tax exempt in many jurisdictions as it is paid with after tax dollars. Basically, the loan obligations over time continue to accumulate as shown in FIG. 4 but are offset by the value of the investment portfolio with the principal protected by a life insurance policy.

The investment entity, be it an insurance company or bank, may also be allowed to loan the value of the investment portfolio to itself for investment. This ability to loan at 0% or other rate, allows access to the funds earmarked for settlement of the loan amount. This process allows the investment entity to have effective access to the funds before final settlement.

The computerized method produces a contract for execution by the lender and purchaser as well as calculates the payments and tracks the performance of the investment portfolio relative to the reference loan.

Monthly or other statements are also generated by the computer. The computer as shown in FIG. 4, has access to various investments and the anticipated rate of return of these instruments. As outlined, the borrower may choose a blend of investment instruments and/or change these investment instruments over time. Basically, this is an investment account used to offset a loan obligation.

As will be apparent to persons skilled in the art, various modifications and adaptations of the method described above are possible without departure from the present invention, the scope of which is defined in the appended claims.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A method for securing of and repayment of a loan amount advanced to a borrower from an investment entity, comprising the steps of:
a) determining a reference loan having an amount equal to the loan amount, the reference loan having a preselected amortization period, interest rate and period of payment;
b) calculating a periodic payment including interest and principal components, such that at the end of the reference loan amortization period the reference loan is repaid in full;
c) determining an investment instrument satisfactory to the borrower and the investment entity, the investment instrument having a preselected estimated rate of return;
d) obligating the borrower to periodically invest a preselected investment amount in the investment instrument, wherein the preselected investment amount is correlated to the periodic payment of the reference loan;
e) said investment entity receiving the proceeds of the investment instrument at a preselected time in satisfaction of the loan, wherein the preselected time is based upon the preselected estimated rate of return loan.

2. The method claimed in claim 1 wherein the investment instrument produces returns which are permitted to build on a tax-free basis.

3. The method claimed in claim 1 wherein the investment instrument includes a life insurance policy on the life of the borrower, the borrower comprising at least one individual.

4. The method as claimed in claim 1 further comprising the steps of periodically calculating an actual rate of return of the investment instrument, and obligating the borrower to invest additional investment amounts in the investment instrument if the actual rate of return of the investment instrument is less than the estimated rate of return.

5. A method for financing a loan of a loan amount to a borrower, the loan being made by a lender and secured by a mortgage security on a property, the borrower comprising at least one individual, comprising the steps of:
a) obligating the borrower to periodically make a premium payment on a life insurance policy on the life of the borrower, the life insurance policy naming the lender as beneficiary, the life insurance policy being cashable for a cash surrender value;
b) arranging for at least a portion of the premium payment to be invested in at least one investment vehicle, the investment vehicle having a preselected estimated rate of return;
c) calculating an estimated cash surrender value of the life insurance policy over time based on the portion of the premium payment to be invested in the at least one investment vehicle and the preselected estimated rate of return;
d) periodically applying the proceeds of the investment vehicle to the insurance policy to increase the cash surrender value thereof;
e) receiving the cash surrender value of the policy at a preselected time in full satisfaction of the loan, wherein the preselected time is based upon the estimated cash surrender value.

6. The method as claimed in claim 5 further comprising the steps of periodically calculating an actual rate of return of the at least one investment vehicle, and obligating the borrower to make additional premium payments if the actual rate of return of the at least one investment vehicle is less than the estimated rate of return.

7. The method as claimed in claim 8 further comprising the step of paying the borrower investment surplus amounts if the actual rate of return of the at least one investment vehicle exceeds the estimated rate of return.

8. The method as claimed in claim 7 further comprising the steps of periodically calculating an actual rate of return of the at least one investment vehicle, and arranging to have the borrower make additional premium payments if the actual rate of return of the at least one investment vehicle is less than a preselected lower rate limit.

9. The method as claimed in claim 7 further comprising the steps of receiving the cash surrender value and the death benefit of the life insurance policy in the event of the death of at least one individual, and discharging the loan in the event of the death of at least one individual.

10. A method for producing a loan agreement defining loan obligations between a borrower and an investment entity associated with the purchase of an asset, said method comprising
determining a loan amount to be advanced by the investment entity to the borrower to complete a purchase of the asset,
said borrower and said investment entity agreeing on an interest rate generally corresponding to a marketplace charge for a loan associated with the purchase of assets similar to the asset,
determining an investment portfolio for said borrower and satisfactory to said investment entity correlated to said loan amount and having an anticipated rate of return sufficient to repay said loan amount and any interest charges based on said agreed interest rate over a preselected period of time,
said investment portfolio requiring said borrower to provide periodic payments to said investment portfolio for increasing the value of the investment portfolio for the eventual settlement of said loan amount,
producing a loan agreement for consideration of said borrower and said investment entity obligating said borrower to make said periodic payments to said investment portfolio in exchange for said investment entity providing said borrower with said loan amount,
said agreement additionally requiring future adjustment of the loan obligations based on the actual rate of return of said investment portfolio over time and said anticipated rate of return.

11. A method for producing a loan agreement as claimed in claim 10 wherein said loan agreement further includes terms providing said investment entity a security interest in said asset exercisable in the event of default of said loan agreement.

12. A method for producing a loan agreement as claimed in claim 11 wherein said future adjustments of said loan obligations are determined on a monthly basis.

13. A method as claimed in claim 11 wherein said future adjustments are determined on a periodic basis less than about 1 year.

14. A method as claimed in claim 11 wherein said investment portfolio includes a life insurance policy for said borrower operable to satisfy any remaining loan obligations in the event of the death of said borrower.

15. A method as claimed in claim 11 wherein said investment portfolio is an investment portfolio offered by an insurance company and has a tax exempt status to said borrower.

16. A method as claimed in claim 15 wherein said agreement includes terms requiring the borrower to provide an additional payment in the event said actual rate of return is less than said anticipated rate of return.

17. A method as claimed in claim 16 wherein said agreement includes terms for varying the loan obligations in a manner favorable to the borrower to reflect any additional value in said investment portfolio when said actual rate of return exceeds said anticipated rate of return.

18. A method as claimed in claim 17 wherein said agreement defines said anticipated rate of return as a specified range and the terms of the agreement do not vary the monthly payments of said loan obligations unless the actual rate of return is outside of said specified range.

19. A method as claimed in claim 15 wherein said agreement requires the creation of an account for said borrower with said investment entity with all periodic payments of said borrower to be deposited in said account, said agreement further including terms allowing said investment entity to withdraw funds from said account corresponding to loan obligations with any remaining funds being invested in said investment portfolio.

20. A method as claimed in claim 10 including using a computer to produce and track said loan agreement.
